(19) United States
(12) Patent Application Publication
(10) Pub. No.: US 2025/0053731 A1
(43) Pub. Date: Feb. 13, 2025

(54) SYSTEMS AND METHODS FOR MACHINE LEARNING-BASED DATA FIELD VALIDATION

(71) Applicant: HSBC SOFTWARE DEVELOPMENT INDIA PVT. LTD., Hyderabad (IN)

(72) Inventors: Sai Raghavendra KANTIMAHANTI, Hyderabad (IN); Sonnu SACHDEVA, Pune (IN); Saket GODASE, Pune (IN); Aditya PATEL, Indore (IN); Claudia Juliet DSOUZA, Pune (IN); Atul KULKARNI, Hyderabad (IN)

(21) Appl. No.: 18/926,178

(22) Filed: Oct. 24, 2024

(51) Int. Cl. G06F 40/174

(52) U.S. Cl. CPC G06F 40/174

(57) ABSTRACT

A system and method for machine learning-based data field validation is proposed that utilizes a specific trained machine learning model data architecture that is adapted to be more resilient against training set class imbalance, using a Siamese triplet LSTM network architecture that uses three LSTMs that are trained together and operate in concert. An example non-limiting practical use includes using the Siamese triplet LSTM network architecture to validate whether free-text data fields include a single jurisdiction in an address or multiple jurisdictions in the address.

### FIELD OF THE DISCLOSURE

The present application relates to computer databases and file management, and more specifically, systems and methods for machine learning-based data field validation using a triplet network machine learning model architecture.

### BACKGROUND

Data field validation, at increasingly large scales, is a major computing problem where inconsistencies and data quality issues in entry (e.g., transpositions, typographical errors, NULL entries) severely impact the ability to conduct downstream automated analysis of the data.

Static rules based approaches have been proposed in an attempt to automatically handle data field validation, but these approaches have been technically limited to application to the specific use cases explicitly provided in the static rules, and an improved solution is desirable to enhance data quality and cleanliness in computer databases and file management.

Another problem with data field validation is that there can be extreme class imbalance in the training data set, for example a large proportion of negative labels, and only a few examples of positive labels.

### SUMMARY

A system and method for machine learning-based data field validation is proposed that utilizes a specific trained machine learning model data architecture that is adapted to be more resilient against training set class imbalance, using a Siamese triplet LSTM network architecture that uses three LSTMs that are trained together and operate in concert. The three LSTMs include a first LSTM trained for positive class embeddings, a second LSTM trained for anchor class embeddings, and a third LSTM trained for negative class embeddings.

A challenge with Siamese networks is that a large amount of data is required for training to be able to establish a sufficient number of examples. In particular, there can be a class imbalance in training data where there is a distribution of training examples of few positive examples and less negative examples. This type of imbalance is a technical problem that arises in respect of a non-limiting applied practical usage of the proposed approach for data field validation where the data fields are being validated against exception cases. A specific example non-limiting use case can be for validating whether a free-text data field (e.g., a user is able to freely enter a string) for an address includes an address in one country, or states multiple countries (multi-country fields). The system can be trained with example datasets having single and multi-country examples, and once trained, can be deployed during inference on an incoming pipeline of fields for classification and single country, multi-country, or inconclusive, for example. In this example, the distribution of training examples is skewed towards single country, as identified multi-country examples are flagged for remediation and replacement as single country fields.

The proposed approach described herein includes a specific training approach as the proposed domain application of the Siamese triplet LSTM network architecture for data validation is a novel usage, adapting approaches from image classification and computer vision tasks. Applicants tested a number of different models and experimentally validated that the proposed Siamese model performed better than alternative models.

A Siamese network consists of two or more identical sub-networks that work in conjunction to validate the inputs and classify them as per the requirement. The overarching objective is the minimization of the distance between embeddings of similar inputs and the maximization of distance between those of dissimilar pairs. The architectural symmetry ensures both inputs are subjected to the same feature extraction process, enabling insights on subtle semantic nuances.

The approach proposed below is an artificial neural network architecture that is designed to be proficient in learning long-term dependencies, especially in sequence prediction problems by way of the specific configuration of the memory architecture, and are a derivative of the recurrent neural network (RNN). Tailored to cater to sequential data, they excel in capturing dependencies between words and phrases, a hallmark of sequential text data. As the layers progress with the classification task, the layers have memory units that contains logical configurations that are used to effectively decide what is important enough to be retained. This enables retaining context around the data and providing output based on a computer estimated representation of experience. The identical sub-networks operate in concert both in training and in inference. As described herein, the proposed identical sub-networks are used in combination with a specific training approach that is well tailored to a specific usage that arises in relation to tasks (e.g., field validation) where there can be extreme skewness in the dataset. The proposed training approach augments the training data in an effort to overcome technical deficiencies in the training data so that different combinations of training elements can be used for effective training (even if there are only very few data elements having a label), which is a core technical benefit of the Siamese network data architecture. Accordingly, despite the deficiencies in the training data, the modified training approach allows the system to utilize the beneficial characteristics of the Siamese network data architecture during inference time.

While not specifically limited to a field validation use case, the field validation use case (where the field validation is being continually remediated over time and thus the population of positive examples continues to dwindle) is a good example of a situation where the training approach is especially useful. The additional training steps and the additional complexity of the identical sub-networks imparts a computational cost and additional complexity, but improved performance during inference is worth the increased computing cost and complexity as the ordered combination of the architecture and the training provides a robust trained model that can be used for field validation even where the training set has extreme class imbalance. This is especially useful in the field validation example because the remediation steps being taken will impart a greater and greater class imbalance over time, and each re-training of the network architecture tunes it based on the latest types of example entries where, for example, input field validation failed to detect or block a user from entering a confusing multiple jurisdiction address input into a free text field that should be for a single jurisdiction address. As described herein, the automated system was able to operate during experimentation for validation in inference against all incoming fields and a further implementation variation is described where the system is coupled to a compliance checking engine where single jurisdictional addresses are accepted, inconclusive addresses are flagged for review, and multi-jurisdictional addresses are rejected for re-processing.

The training for the Siamese triplet LSTM network architecture can include a first step of cleaning the data and tokenization. Once the data is cleaned and tokenized, the training-test datasets, and the training data is segmented into the positive, negative and anchor (reference) data classes. As the model training progresses, the goal is to minimize the difference between anchor and positive data. The process keeps on repeating until the loss is minimized or after a period of time has elapsed. In the non-limiting data field multi country validation example, a positive class label can be indicative of a multiple country text input. The multi country validation example can be based on determining whether a free-text input fields that is either associated with a single ISO country code (e.g., GB), or multiple country codes. This use case can be important, for example, in determining which jurisdictional compliance requirements must be met to process a related transaction.

The training includes generating triplet data objects (e.g., vectorized examples) for training. During each training iteration, a positive example, an anchor example, and a negative example, are all provided to the Siamese network to update parameters of the models underlying the Siamese network. In an iteration, the Siamese network attempts to classify the anchor example based on distances established by the positive and the negative network, and a ground truth label known for the anchor example can be used to “reward or penalize” the network to control parameter updates of the underlying networks.

A benefit of using a triplet data object training approach is that different permutations of data set elements can be selected for triplets, and thus the technical deficiency of having extreme label imbalance can be addressed by effectively using any two examples as positive and negative, and then selecting an anchor selected from the other examples. For example, despite the dataset having very few positive examples, the training dataset can be used to generate a significant number of triplets based on different possible permutations of the data set elements as negative and anchor training elements, increasing the utility of the training set despite its technical limitations using the triplet network.

This is especially important as in the multi-address example, the number of training set elements with positive labels are quickly reducing as legacy approaches and source systems are increasingly adapted to avoid multi-address examples through stronger input field validation. However, because the fields are free-text fields, despite best efforts in rules-based field validation, there will be multi-country field entries that will be entered, and the proposed system and the Siamese network assists in catching these entries. As noted herein, the proposed Siamese network architecture is especially useful for this specific applied use case because even if the dataset is very skewed, even a small number of examples is enough to train the Siamese network for acceptable performance during inference.

Once trained, the Siamese triplet LSTM network architecture is used to generate machine outputs that automatically validate data fields (e.g., name and address fields) that operates in conjunction with a data pipeline for automated ingesting of incoming and outgoing payment transactions data, in particular name and address of remitter and beneficiary, from a primary/original source location. The output is a probability score that indicates the category for each address. In the context of a multi-country address for example, the output may be in a form of a probability value between 0 and 1 that indicates whether the input address is classified as multi-country or not. One of the aspects of the validation engine is the machine learning model that ensures validations such as the multi-country address problem are handled intelligently and with a “first pass” estimated computer-based approximation.

During inference, the Siamese architecture can be used to process a new data point to establish one or more triplets for inference generation, where the data point can be set as an anchor and different combinations of extant positive and negative examples can be used for distance determination. The generated outputs can be used to scan through addresses that are entered in real-time, or large datasets of entered addresses. Because the system is able to operate quickly and efficiently, instead of relying on approaches that inspect a randomly selected subset of samples, Applicants found that the computing approach was sufficiently fast to be able to evaluate every entered address despite computing resource and processing time limitations.

The generated output can be used to extend a data structure associated with a particular request data object. For example, a relational database may be augmented to add a column with a label (e.g., TRUE/FALSE/Manual Review based on whether a field is estimated by the model inference to be classified as multicountry label or not). In this example, the output logic gates may be configured to only output TRUE if a normalized value, p (multicountry)>0.99=TRUE, FALSE if single label/class>0.99=FALSE, and otherwise flag for manual review. On manual review, a reviewer can determine whether a particular text string is multi country or single country, and the system can be configured to automatically collate these reviewed examples for generating a re-training dataset that is used in a training feedback loop.

Applicants also experimented with different approaches for hyperparameter and model selection to tune the model to optimize performance. It was observed that the Siamese model with triplet works well for the practical use case. Applicants also conducted hyperparameter tuning by modifying and tuning single hyperparameters and identified hyperparameters such as vector sizes that provide better accuracy.

The system can be practically implemented as a special purpose computing device that operates, for example, as a computer server in a data center or on distributed computing resources controlled by a supervisor or hypervisor system. The system is adapted for machine learning-based data field validation, and receives input datasets that are provided from a data pipeline coupled to a message bus, either as batches or in real-time. During a training phase, the input datasets can be datasets where the true label is known, and a training approach according to embodiments described below can be utilized. Once the model is trained (e.g., the parameters/weights of the underlying triplet LSTM are configured), the model can be used during inference against input datasets received for classification. The system generates one or more data structure outputs including the classification outputs, and as described herein, the classification outputs can be merged into data structures as additional columns or data fields representing augmented metadata. The classification outputs and the corresponding input strings are then provided, either in full or condensed form, to downstream computing devices or processes that are utilized for downstream computing activities such as running jurisdiction specific compliance checking sub-processes against associated transaction information, conducting additional review of field validation, or rejecting inputs and automatically triggering a re-request workflow to request a user to correct a free text input as it appears to be directed to multiple jurisdictions. The system can be configured for periodic re-training using a latest batch of processed examples, which can optionally include human verified labels where the machine learning inputs were inconclusive. For the field validation example, as the proportion of multi-jurisdiction labels continues to decrease, the proposed training approach using the triplet architecture becomes more and more technically important.

The foregoing has outlined the features and technical advantages in order that the detailed description that follows may be better understood. Additional features and advantages will be described hereinafter. It should be appreciated that the conception and specific embodiment disclosed may be readily utilized as a basis for modifying or designing other structures. It should also be realized that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1A and FIG. 1B show a block schematic view of a proposed Siamese network that can be used along with a dense layer, according to some embodiments.

FIG. 2A is an example prior art diagram of a manual process for validating for validating name and address data using static rules.

FIG. 2B is an example process diagram which can be implemented on a computer system that enables automated ingesting of incoming and outgoing payment transactions data, in particular name and address of remitter and beneficiary.

FIG. 3 is an example architecture diagram showing an examples system schematic for incorporating a proposed machine learning solution adapted to perform effective validation of the payment transaction data set to augment validation approaches under payments transparency doctrines, according to some embodiments.

FIG. 4 is an example architecture diagram showing an example practical implementation of the system, according to some embodiments.

FIG. 5 is an example method diagram showing a series of steps for a process for machine learning-based data field validation, according to some embodiments.

FIG. 6 is an example system output, according to some embodiments, including address inputs where some are multiple country fields, some are not multiple country fields, as well as the associated confidence scores.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

A system and method for machine learning-based data field validation is proposed that utilizes a specific trained machine learning model data architecture that is adapted to be more resilient against training set class imbalance, using a Siamese triplet LSTM network architecture that uses three LSTMs that are trained together and operate in concert. The usage of the Siamese triplet LSTM network for usage in free text field validation is an innovative contribution as Siamese triplet model architectures were previously used in relation to image processing. In the proposed approach described herein, the approach is adapted to address issues with training data, namely extreme class imbalance. The specific non-limiting use case used to develop and experiment upon this approach was a use case where there were very few positive examples and a very large number of negative examples. While specific discussion is made below in respect of processing data message object payloads relating to outbound payment flows, other variations are possible.

Applicants also tested other models, such as using static models using if-else statements, investigating text fields one-by-one and proceeding hierarchically until certain condition is satisfied. Another approach attempted was to train a context-aware machine learning model for a binary prediction, testing neural network models with and without metadata. The experimental models yielded inferior performance to the proposed Siamese triplet model architecture described herein.

In a non-limiting example, the approach is can be used in an applied practical scenario for automation of extensive rules applicable for name and address field checks that are required for Industry Compliance under Financial Action Task Force (FATF)-Payments Transparency Requirements (PTR), among others. In these compliance checks, a threshold question is which jurisdictional regulatory requirements must be followed, and it is important to associate a particular record (e.g., a transaction) with a particular jurisdiction. The problem arises with free text address fields where a user is able to write in an address, and occasionally, a user or a system inputs a text field that appears to relate to multiple countries. This can occur, for example, as a typographical errors, or due to a user inputting in both an operating entity address and a headquarter address, or for other reasons. While explicit rule validation approaches can catch some of these malformed inputs, they are unable to catch every input variation. The specific issue to be avoided occurs during technical processing of a transaction where a multiple address input is not caught during a review stage. While the transaction may be processed and may be routed properly, a compliance issue may arise as the wrong jurisdiction is flagged.

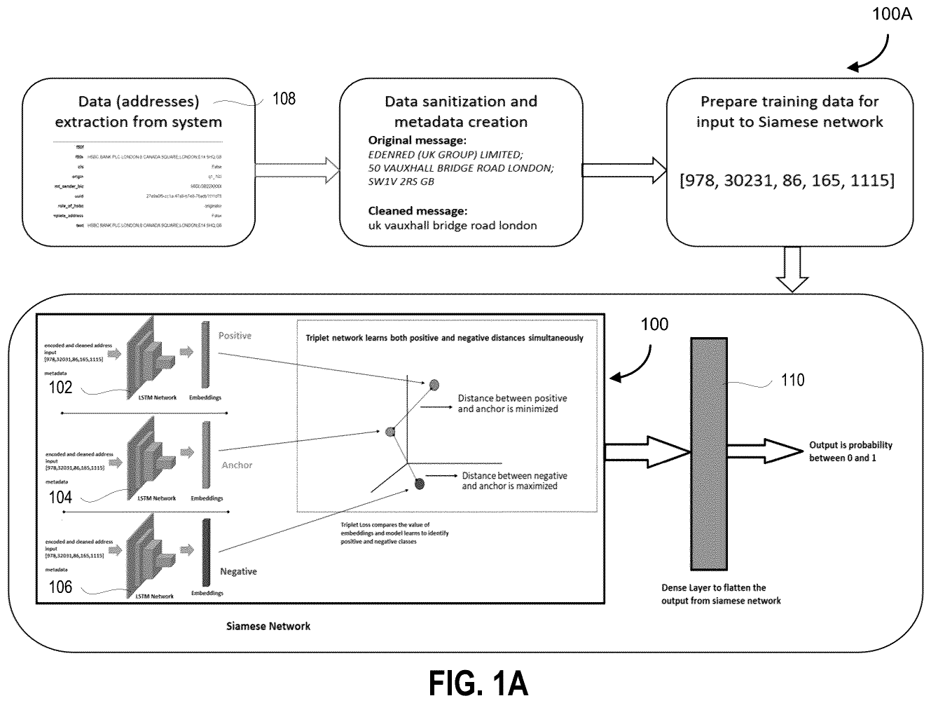

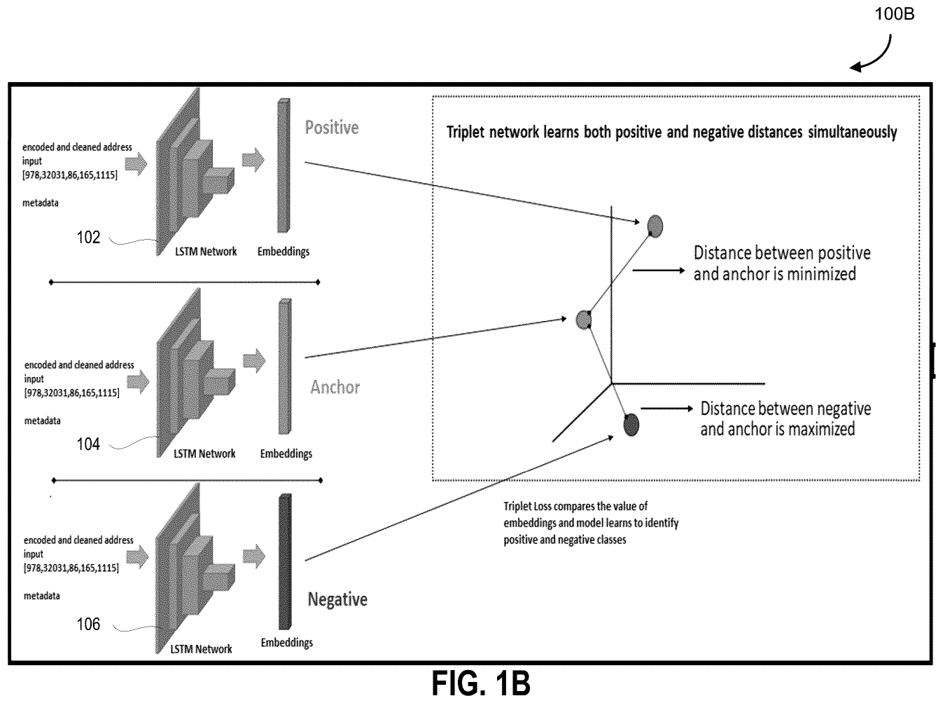

FIG. 1A is a block schematic view of a proposed Siamese network that can be used along with a dense layer, according to some embodiments. The fusion of Siamese networks with LSTM layers embodies a synergy of architectural concepts. While Siamese networks are adept at discerning similarity or dissimilarity between data points, LSTM layers are tailored for modeling sequences, capturing intricate, long-range dependencies within text data. Used in conjunction, these two elements significantly elevate the accuracy and precision of text classification. FIG. 1B is an enlarged view of the Siamese network, showing a triplet network architecture.

It is important to note that Siamese networks are not normally used for text classification, but for image classification. For this model, during experimental approaches, an carlier attempt was made to utilize the model it was discarded as there did not appear to be feasible. As described herein, a proposed improved training approach for augmenting a limited dataset and effectively using permutations or combinations thereof is described that is used in conjunction with the proposed architecture to provide a useful mechanism that overcomes technical limitations of Siamese network architectures. The proposed approach is adapted for usage in text classification models which focuses on a “few-shot” learning process-understanding new concepts from a few examples and assist in finding similarity in inputs. This approach is especially helpful for attempting to solve the text field multi-country address problem, to classify payment addresses into multi-country vs single country. The output is a probability score that indicates the category for each address.

The Siamese network architecture 100 includes three LSTMS 102, 104, and 106. The three LSTMs include a first LSTM 102 trained for positive class embeddings, a second LSTM 104 trained for anchor class embeddings, and a third LSTM 106 trained for negative class embeddings. In an applied usage scenario, the system can be used as part of a name and address compliance tracking system in accordance with PTR for FATF for incoming and outgoing payments messages (MT103, 202 COV multi-country; also applicable to pacs.008, pacs.009 COV) based on rules as prescribed from time to time (also referred to as static rules hereafter). Identified identification of outliers is also proposed herein for subsequently parsing for permutation and combination of interdependencies in rules based on nature of payment message that require operational actions, diligence and reporting as per PTR.

A classification model is connected (e.g., built on top of) with the Siamese network architecture 100 and the output of the Siamese network architecture 100 is passed to classifier model which makes the final prediction. As described in more detail herein, the Siamese network architecture 100, which is trained using triplet loss, is configured to learn, during training, an embedding space where distances between similar examples are minimized and the ones between dissimilar examples are maximized.

When a new input example is passed through the Siamese network, it generates a vector representation (embedding) of the input. This vector captures the essential features of the input in a way that reflects the similarity relationships learned during training. The classification model receives as an input, the embedding (output from the Siamese network architecture 100). The model could be a feedforward neural network (or any classifier like SVM, logistic regression) that has been trained to classify the embeddings into two categories (for binary classification). During training, this classifier learns to distinguish between the embeddings of positive and negative examples generated by the Siamese network architecture 100.

The Siamese network 100 comprises identical sub-networks that work in conjunction to validate the inputs and classify them as per the requirement. The overarching objective is the minimization of the distance between embeddings of similar inputs and the maximization of distance between those of dissimilar tuples. The architectural symmetry ensures both inputs are subjected to the same feature extraction process, enabling insights on subtle semantic nuances.

Each of three LSTMS 102, 104, and 106 are artificial neural networks that are proficient in learning long-term dependencies, especially in sequence prediction problems. A derivative of the recurrent neural network (RNN), LSTMs occupy a pivotal role in the architecture. Tailored to cater to sequential data, they excel in capturing dependencies between words and phrases, a hallmark of sequential text data. As the layers progress with the classification task, there are memory elements in storage that are adapted to enable improved determinations to decide what is important enough to be retained. This enables retaining context around the data and providing output based on experience.

The three LSTMS 102, 104, and 106 operate based on a triplet loss function, that is configured to measure how well the machine learning model fits the specific data set by quantifying the difference between predicted and actual values.

For example, the model may be in the process to be trained to learn “CITYPOINT (JERSEY) UNIT TRUST;47 ESPLANADE ST HELIER JERSEY JE1 0;BD GB” as a “multiple country” address. In this example, the model is configured to ensure that the distance between positive and anchor is smaller than the distance between anchor and negative. An example of positive and negative embeddings in this case would be as below:

### Example

POSITIVE−CLARIS III LTD;13 CASTLE STREET ST HELIER JERSEY J;E4 5UT GB

ANCHOR−CITYPOINT (JERSEY) UNIT TRUST;47 ESPLANADE ST HELIER JERSEY JE1 0;BD GB

NEGATIVE−DAVID HOLLIS ALLEN; THURLOE SQUARE

25;GB/LONDON/SW7 2SD

The distance can be determined using a pairwise distance function, that computes the distance between pairs of samples in a dataset. It can be determined using the formula, f(a,b)=∥a∥b|\hat{ }2=∥a∥\hat{ }2−2<a, b>+∥b∥\hat{ }2, positive_distance=f(anchor, positive), and negative_distance=f(anchor, positive). The training data for Siamese network is prepared using these triplet distances and loss functions.

The learning (or this case the classification) problem is converted into an optimization problem, a loss function is defined, and the algorithm is optimized the minimize the loss function.

The loss function is represented by the formula:

$$L = max ( d ( a , p ) - d ( a , n ) + margin , 0 )$$

The variable “a” represents the anchor text, “p” represents a positive text and “n” represents a negative text. Another variable called margin, which is a hyperparameter is added to the loss equation. Margin defines how far away the dissimilarities should be, example: if margin=0.3 and d (a, p)=0.5 then d (a, n) should at least be equal to 0.7. Margin helps distinguish between two values better.

The gradients (differences) are calculated using the loss function. With the help of the gradients, the weights and biases of the Siamese network are updated.

As an example, the string: LANGLOIS LTD;GRANT THORNTON 46/50 KENSINGTON CHA;MBERS KENSINGTON PLACE ST HELIER JE;RSEY JE1 1ET GB may be provided to generate an output.

The raw output of the Siamese network in this example would be an array having the following values: array

([0. , 0. , 0. , 0. , 0. ,
0. , 0. , 0. , 0. , 0. ,
0. , 0. , 0. , 0. , 0. ,
0. , 0. , 0. , 0. , 0. ,
0.60552156, 0. , 0. , 0.1376153 , 0.07698224,
0.10337615, 0. , 0.07088812, 0. , 0. ,
0. , 0. ], dtype=float32)

In this example, the output probability represents the output of classification layer would be a vector containing probability of 0(NOT MULTIPLE COUNTRY) and 1 (Multiple Country). Accordingly, for the above example, [0.01582, 0.9841]→indicates that should have a multi country label.

The proposed system can be used to receive a pipeline 108 of money transfer transaction data (money transfer hereafter also alternatively referred payment transactions). In comparison to previous decades, volume of payment transactions from financial institutions, corporates and individuals has increased significantly. A dense layer 110 can be utilized to flatten the output from the Siamese network to generate a normalized output probability for positive and negative classes.

This pipeline of data 108 can be used during inference operation of the Siamese network architecture 100 to generate the output augmentations.

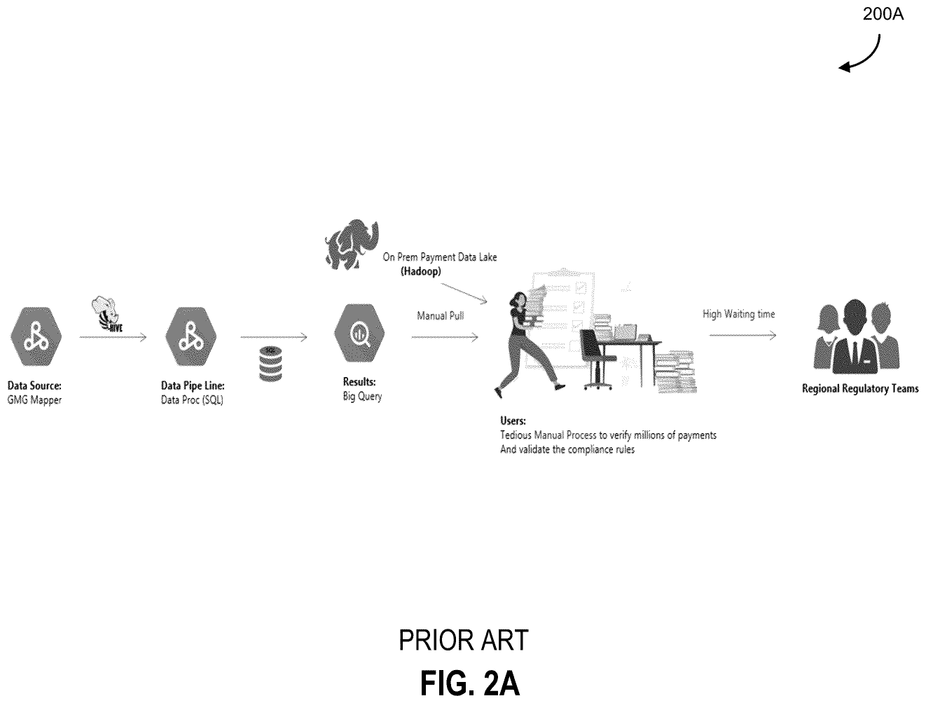

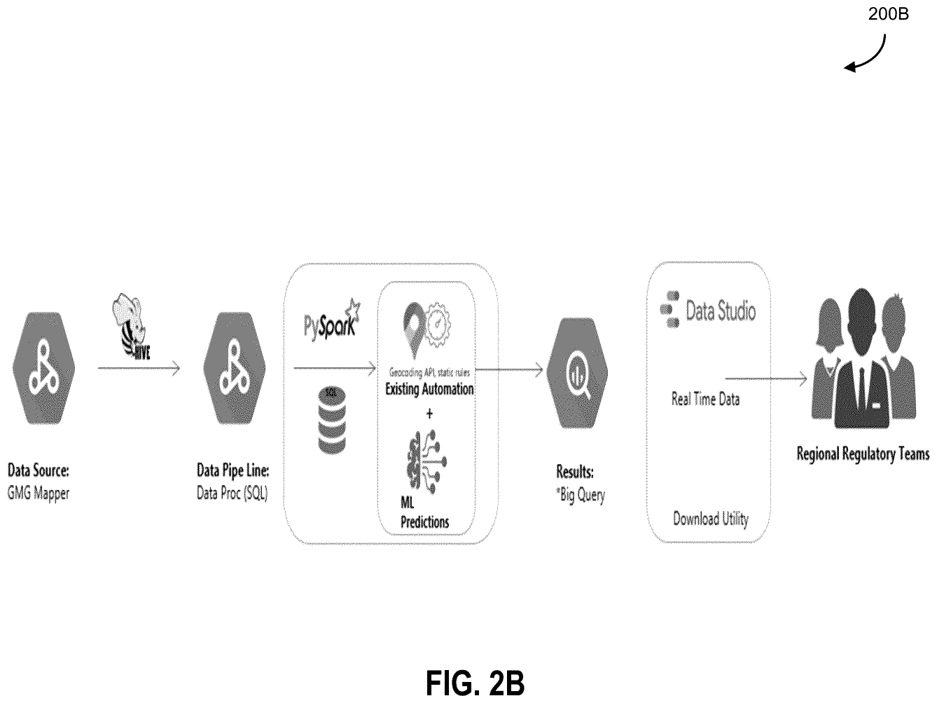

FIG. 2A is an example prior art diagram of a manual process for validating for validating name and address data using static rules. FIG. 2A illustrates a process 200 for validating Name and Addresses data as per prescribed static rules as mandated under Payments Transparency. Data sources are referred as GMG Mapper. This is a system where payments data post transaction processing is maintained. Data processes (e.g., using SQL queries) for movement of data from data source into destination location are utilized, and payment operations users' access the data to manually perform Name and Addresses data as per prescribed static rules as mandated under payments transparency. A Big Query system is used as the destination system for storing the data sets for validations. Results of validation are then manually (email/other approved channels) are shared with a regional regulatory team. A problem with this approach is that the manual reviewers do not have the capacity to review every entry, and thus are limited to conducting a randomized review.

FIG. 2B is an example process diagram which can be implemented on a computer system that enables automated ingesting of incoming and outgoing payment transactions data, in particular name and address of remitter and beneficiary. The process 200B shows an approach for generating ML predictions from data received from a primary/original source location (Inhouse system data source noted as GMG Mapper), which are generated and transmitted to secondary location (e.g., a Big Query system setup) where results of the automated rules validation process are stored. Rules utilized can comprise a combination of static rules (as prescribed by Payment Transparency and additional rules generated through Machine learning solution are applied). This also comprises of a data pipeline system to move data from one location to another (e.g., shown here as Data Proc SQL).

Applicants also experimented with different approaches for hyperparameter and model selection to tune the model to optimize performance.

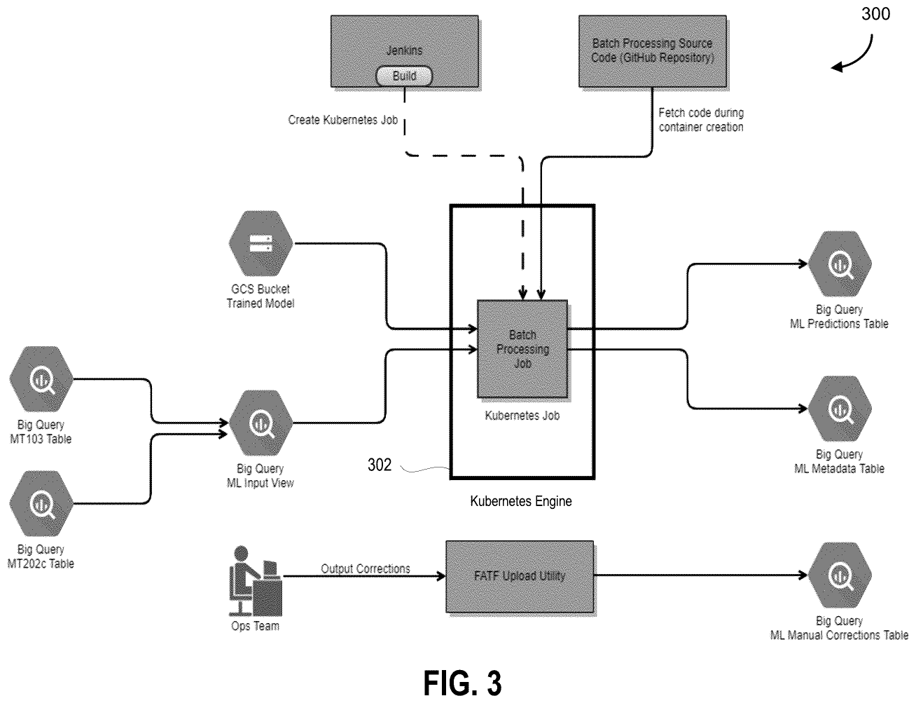

FIG. 3 is an example architecture diagram showing an examples system schematic for incorporating a proposed machine learning solution adapted to perform effective validation of the payment transaction data set to augment validation approaches under payments transparency doctrines, according to some embodiments. The machine learning model is conducted through a series of batch processing jobs that are controlled by a Kubernetes engine 302, which receives datasets through the data pipeline 108 for classification. The Kubernetes engine 302 can be configured to operate an initial training process using a set of tuples and correct labels on an instantiated triplet Siamese network. The instantiated triplet Siamese network is iteratively trained using the input data set, the input data set augmented to generate tuples based on possible tuple/triplet combinations to overcome distribution issues in the data set. The Kubernetes engine 302 can be utilized to generate both a ML predictions table, which is then converted into metadata using the ML metadata table for augmenting the data structures as described herein. For outputs that are not classified as either positive or negative labels confidently, these output corrections can be used to generate a new training set that is labelled by manual review to establish a new training set for automatic retraining of the system 100. The approach of FIG. 3 helps increase in efficacy of automated validations and can handle ambiguous scenarios, configured using a triplet network in an attempt to develop computationally a nuanced representation in the latent spaces that has approaches converging at least towards those of a manual tester.

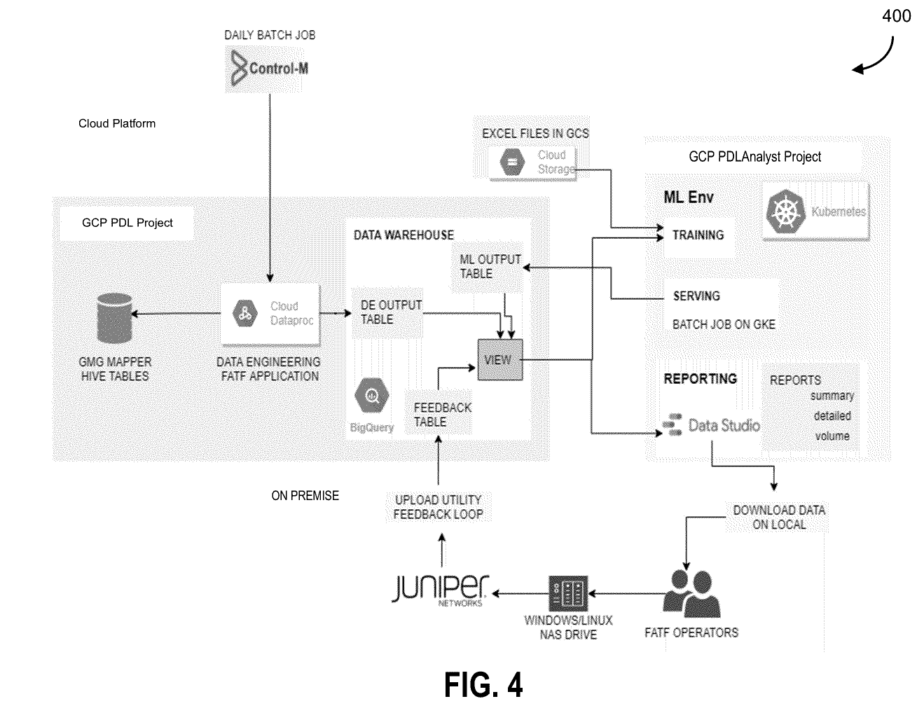

FIG. 4 is an example architecture diagram showing an example practical implementation of the system, according to some embodiments. A feedback loop is shown in diagram 400 where operators and analyst outputs are re-used for retraining the underlying models.

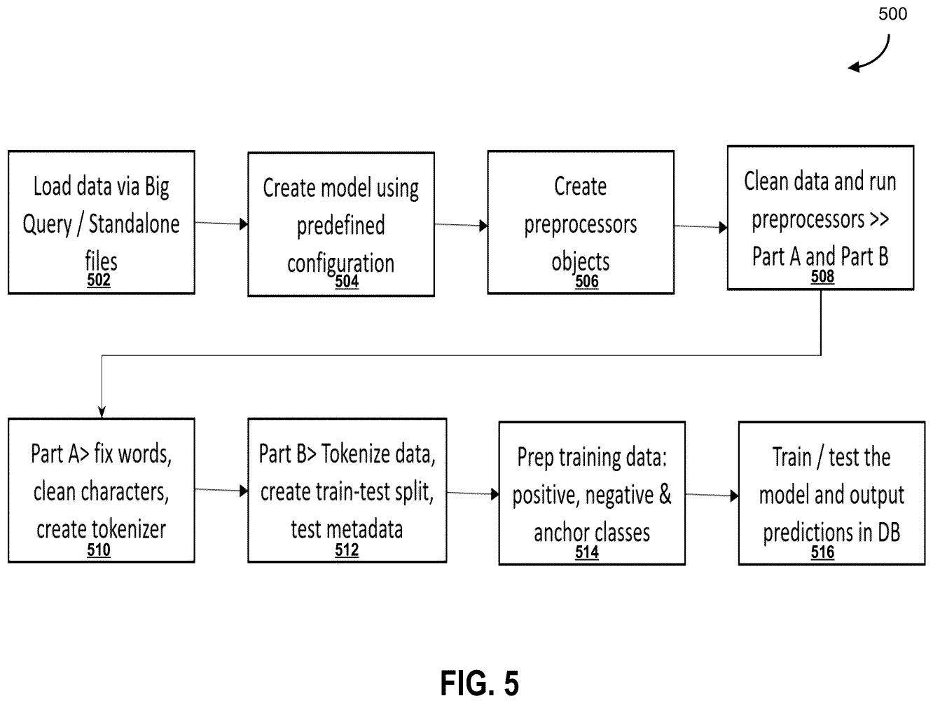

FIG. 5 is an example method diagram showing a series of steps for a process for machine learning-based data field validation, according to some embodiments. The proposed approach described herein includes a specific training approach as the proposed domain application of the Siamese triplet LSTM network architecture for data validation is a novel usage, adapting approaches from image classification and computer vision tasks.

As noted, a challenge with Siamese networks is that a large amount of data is required for training to be able to establish a sufficient number of examples. In particular, there can be a class imbalance in training data where there is a distribution of training examples of few positive examples and less negative examples. This type of imbalance is a technical problem that arises in respect of a non-limiting applied practical usage of the proposed approach for data field validation where the data fields are being validated against exception cases.

A specific example non-limiting use case can be for validating whether a free-text data field (e.g., a user is able to freely enter a string) for an address includes an address in one country, or states multiple countries (multi-country fields). The system can be trained with example datasets having single and multi-country examples, and once trained, can be deployed during inference on an incoming pipeline of fields for classification and single country, multi-country, or inconclusive, for example. In this example, the distribution of training examples is skewed towards single country, as identified multi-country examples are flagged for remediation and replacement as single country fields.

In the approach steps 502, 504, 506, 508, 510, 512, 514, and 516 are shown. In this example flow, the machine learning ingestion, training and testing approaches are shown. Steps 502-508 are approaches to instantiate the model and to prepare an untrained model for training.

The first step 510 is to clean the input data so that all inputs fed into the model are uniform in nature.

This involves:
a. Fixing words that are split due to semi-colons.
b. Removal of numeric and alphanumeric data.
c. Removal of unwanted characters and stop words.
d. Removal of single character words.

The second step 512 is to use the cleaned data and split it into meaningful parts via a process called as tokenization. This helps in understanding context of the words and interpreting the meaning of the text by analyzing the sequence of the words. In the specific example applied use case relating to address fields, the country reference data is used to perform tokenization using the cities, countries, ISO codes etc.

Once the data is cleaned and tokenized, the next step 514 is to create the train-test datasets and prepare the training data into the positive, negative and anchor (reference) data classes. As the model training progresses, the goal is to minimize the difference between anchor and positive data. The process keeps on repeating until the loss is sufficiently minimized or an amount of time has elapsed.

The training includes generating triplet data objects (e.g., vectorized examples) for training. During each training iteration, a positive example, an anchor example, and a negative example, are all provided to the Siamese network to update parameters of the models underlying the Siamese network.

In an iteration, the Siamese network attempts to classify the anchor example based on distances established by the positive and the negative network, and a ground truth label known for the anchor example can be used to “reward or penalize” the network to control parameter updates of the underlying networks.

A benefit of using a triplet data object training approach is that different permutations of data set elements can be selected for triplets, and thus the technical deficiency of having extreme label imbalance can be addressed by effectively using any two examples as positive and negative, and then selecting an anchor selected from the other examples. For example, despite the dataset having very few positive examples, the training dataset can be used to generate a significant number of triplets based on different possible permutations of the data set elements as negative and anchor training elements, increasing the utility of the training set despite its technical limitations using the triplet network.

This is especially important as in the multi-address example, the number of training set elements with positive labels are quickly reducing as legacy approaches and source systems are increasingly adapted to avoid multi-address examples through stronger input field validation. However, because the fields are free-text fields, despite best efforts in rules-based field validation, there will be multi-country field entries that will be entered, and the proposed system and the Siamese network assists in catching these entries. As noted herein, the proposed Siamese network architecture is especially useful for this specific applied use case because even if the dataset is very skewed, even a small number of examples is enough to train the Siamese network for acceptable performance during inference,

As noted below, an innovative training approach is proposed to address the technical challenge that arises from using Siamese networks (which require large robust data sets), and a heavily skewed training data set. The below approach effectively is used as an improved training approach to automatically augment the training data set by extending the number of elements by taking advantage how a triplet network can be trained. This augmentation is a specific applied improvement that allows for practical usage of a Siamese network architecture, despite the technical deficiencies.

An example training approach is provided below as a non-limiting example:

```
  Input Example → Siamese Network → Embedding (e.g., [0.5, −0.2,
  0.8]).
  Embedding → Classification Model → Output (e.g., class 1 or
probability 0.85 for class 1).
```

The Siamese network provides a representation of the input, and the classification model interprets this representation to make a binary decision. The model combines the embedding power of the Siamese network with the decision-making ability of the classifier.

In a triplet network, each training example consists of three images:
Anchor (A)>the reference example.
Positive (P)>an example of the same class as the anchor.
Negative (N)>an example from a different class than the anchor.

If there are 4 positive examples and 500 negative examples, the triplet generation process would involve:
1. Selecting one of the 4 positive images as the anchor.
2. Selecting one of the other 3 positive images as the positive.
3. Selecting one of the 500 negative images as the negative.

This process is repeated multiple times to generate a large number of triplets for training the Siamese network. This generation process is automated and is a pre-stage that is used to automatically augment and extend the training set, and allows for improved training that is specifically configured for improved operation of the Siamese network architecture, overcoming the technical challenges related with providing enough examples

```
Example:
For Positive Example 1:
  Anchor: Positive 1
  Positive: 4 possible values: Positive 1 | Positive 2 | Positive 3 |
  Positive 4
  Negative: Any one of the 500 negative examples
```

This can be done for all four positive examples. Total number of combinations for generating triplets: 4 anchors*4 positives*500 negatives=8,000 possible triplets.

Accordingly, even in the non-limiting applied use case described herein, such as for field validation where there is an increasingly shrinking number of positive examples (e.g., as they become remediated or the effectiveness of validation mechanisms improves), the Siamese network can still be used in the long run because of the improved training approach noted above where a highly skewed dataset can nonetheless be used to generate a large number of possible triplets. This is an important factor in improving the viability of the machine learning model architecture for continued usage over a long duration despite the continued shifting of the training data sets towards to have more and more skewness.

Once the training is completed the model is used on the testing data sets at 516. The output is provided in the form of a probability value between 0 and 1 that indicates whether the input address is classified as multi-country or not. Once trained, the Siamese triplet LSTM network architecture is used to generate machine outputs that automatically validate data fields (e.g., name and address fields) that operates in conjunction with a data pipeline for automated ingesting of incoming and outgoing payment transactions data, in particular name and address of remitter and beneficiary, from a primary/original source location.

The output is a probability score that indicates the category for each address. In the context of a multi-country address for example, the output may be in a form of a probability value between 0 and 1 that indicates whether the input address is classified as multi-country or not. One of the aspects of the validation engine is the machine learning model that ensures validations such as the multi-country address problem are handled intelligently and with a “first pass” estimated computer-based approximation.

During inference, the Siamese architecture can be used to process a new data point to establish one or more triplets for inference generation, where the data point can be set as an anchor and different combinations of extant positive and negative examples can be used for distance determination. The generated outputs can be used to scan through addresses that are entered in real-time, or large datasets of entered addresses. Because the system is able to operate quickly and efficiently, instead of relying on approaches that inspect a randomly selected subset of samples, Applicants found that the computing approach was sufficiently fast to be able to evaluate every entered address despite computing resource and processing time limitations.

The generated output can be used to extend a data structure associated with a particular request data object. For example, a relational database may be augmented to add a column with a label (e.g., TRUE/FALSE/Manual Review based on whether a field is estimated by the model inference to be classified as multicountry label or not).

In this example, the output logic gates may be configured to only output TRUE if a normalized value, p (multicountry)>0.99=TRUE, FALSE if single label/class >0.99=FALSE, and otherwise flag for manual review. On manual review, a reviewer can determine whether a particular text string is multi country or single country, and the system can be configured to automatically collate these reviewed examples for generating a re-training dataset that is used in a training feedback loop.

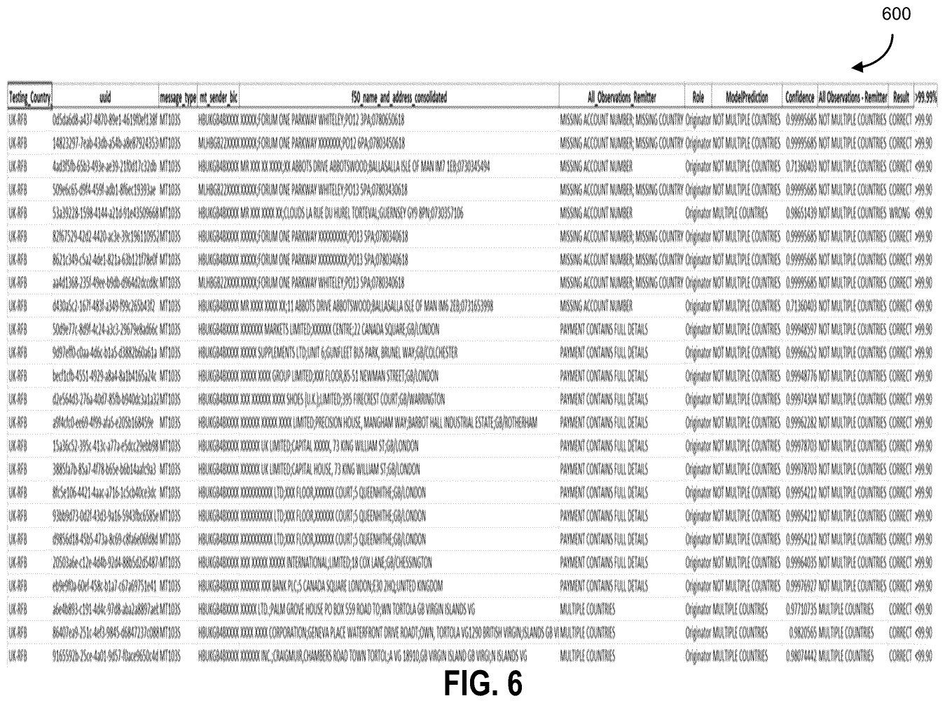

FIG. 6 is an example system output, according to some embodiments. The screenshot 600 is an actual output screen of an example relational database query tool. As shown in 600, additional fields are augmented to the data structure. In this example, the ML output is provided as ModelPrediction and Confidence, and the observation/result fields are based on review of the machine learning model predictions. The final column is an added field relating to whether the confidence score was past the threshold for a confident labelling. In some embodiments, if the confidence is less than a threshold, such as 99.9%, the data record is flagged for manual review and eventual dataset retraining in a feedback engine. Accordingly, the system 100 can be re-trained and updated automatically as review processes are undertaken such that each review adds to the overall re-training and re-weighting of parameters of the model. Over enough training and retraining epochs, the system improves its estimation ability through incremental refinements to the model parameters.

As input validation approaches advance, the total number of multiple jurisdiction entries should reduce over time, and as noted herein, this makes the class imbalance dataset issue more and more pertinent as a technical problem. The proposed triplet network architecture approach thus becomes increasingly important to help provide a mechanism to overcome these issues through an improved training process, albeit with additional training computing costs incurred through generating augmented datasets for training all three of the LSTMs at the same time with different combinations of data elements used as positive, negative, and anchor. Despite having only a diminishing number of positive examples, the system is still able to effectively train and provide a practically useful classification machine with strong classification capabilities through the technical characteristics of the machine learning architecture.

Applicants tested a number of different models and experimentally validated that the proposed Siamese model performed better than alternative models.

An experimental example is shown below:

The following address would be identified as multi-country via static rules, and this is an example where the ML approach using system 100 provides a more nuanced and correct output classification.

f50_name_and_address: MR SEAN CHRISTOPHER EASTES;P O BOX 3247 CRESTA 2118 SOUTH AFRI;CA ZA

Static rules output: multi-country address: CA-Canada, ZA-South Africa

ML model output: not a multi-country address

The model was initially tested on payments data labeled by the Operations team and subsequently on payments data spread over three quarters. Experimental outcome results are specified below:

Training phase:
Total number of addresses=15,837
Multi country addresses=2,162
Not multi country addresses=13,674
Results: Accuracy=99.99%

Testing phase:
Cycle 1 (Q4 2022 data):
Accuracy=99.99%
Test coverage=94.45%
Cycle 2 (Q1 2023 data):
Accuracy=100%
Test coverage=94.41%
Cycle 3 (Q2 2023 data):
Accuracy=100%
Test coverage=94.78%

With the advent of globalization, there is an increase in business and individual transactions within countries and across different countries & regions. Cross-border money transfer transactions are therefore on the rise. A cross-border money transfer is a transaction where money is sent by an entity from country A to an entity in country B.

It can be difficult to ascertain the motive behind the money transfer. With rise of global terrorism, many governments now mandate that such cross-border transactions be monitored for potential money laundering activities other unlawful activities. Amidst fears of banks being used as vehicles for financial crime, international organizations are asking banks to enhance the monitoring of international payments, which are payment initiated by them or where they act as intermediary on the chain of payments.

Regulatory action related to payments transparency is multi-layered: global, regional, and country-level requirements present a complex challenge for financial institutions and their corporate clients. Perhaps most noteworthy to date is the Financial Action Task Force (FATF). Introduced in 2012, these specified new recommendations for originator and beneficiary information in payment messages. In the EU, these recommendations were implemented via the Funds Transfer Regulation. Payment's transparency is also addressed in the EU Directive (EU) 2015/849 on the prevention of the use of the financial system for the purposes of money laundering or terrorist financing.

The basic of focus amongst others like KYC (know your customer), is the quality in the completeness and correctness of the payment message itself that gets transmitted to affect the payment. Regulatory efforts are focused on ensuring any payment transaction is accompanied by critical information such as the names, addresses and country of origin of the ultimate payers and beneficiaries.

Missing information can create returned or rejected payments, causing delays in processing. The ability to provide such information accurately and in a timely manner to banking partners will deliver benefits of reduced costs and faster payments processing.

The problem statement of multi-country address issues for MT 103, MT 202 COV is being addressed via the proposed machine learning (ML) solution. The ML model focused on text classification, consist of the Siamese network with Long Short-Term Memory (LSTM) layers and triple loss function. Text classification, a foundational task in natural language processing (NLP), holds substantial significance across domains, from sentiment analysis to document categorization. The proposed ML model as described herein can be utilized as a useful practical implementation of a tool for automated validation processing for free text fields, where there is significant imbalance in class representation in training sets. The specific Siamese triplet data architecture in combination with the training approach provides a useful technical contribution that overcomes technical deficiencies that are otherwise prevalent in Siamese model architectures or based on challenges in the received dataset pipeline (e.g., extreme class imbalance) that yields other approaches technically unfeasible. The machine can be configured as a special purpose computing appliance that operates to receive a data pipeline and automatically generate classification outputs, and automatically invoke downstream computing processes based on the classification outputs and the confidence scores as noted in examples herein. For example, the downstream computing processes can include flagging certain records for re-verification and ultimately for re-use during periodic re-training by generating a condensed dataset of re-verified records (useful for re-tuning where input validation approaches are being improved over time, causing a dataset drift due to changes in the environment), or automatically rejection or automatic approval to a next step in a batch processing data flow. For example, a next step may be to associate a record with a jurisdiction specific compliance workflow called through an API, and one of the requirements for the API to accept a record for processing is that the system 100 will have had to classify the corresponding free text field at a high confidence as being of a single jurisdiction only, otherwise it is reinserted into the pipeline for review after revision.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

The functional blocks and modules described herein may comprise processors, electronics devices, hardware devices, electronics components, logical circuits, memories, software codes, firmware codes, etc., or any combination thereof. In addition, features discussed herein may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the clement with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified-and includes what is specified; e.g., substantially 90 degrees includes 90 degrees and substantially parallel includes parallel-as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of-rather than comprise/include/have-any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic device, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or other configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, clements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus-or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. Processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for machine learning-based data field validation of free-text inputs using a Siamese triplet long-short term model (LSTM) network architecture, the system comprising:
a computer processor operating in conjunction with a non-transitory computer memory and data storage, the computer processor configured to:
receive, at a data receiver interface, a dataset having one or more positively labelled records and one or more negatively labelled records, the dataset having a class imbalance between a number of positively labelled records and a number of negatively labelled records;
instantiate, by a machine learning training engine, an untrained Siamese triplet LSTM network architecture including a first LSTM configured for learning a positive class embedding, a second LSTM configured for learning an anchor class embedding, and a third LSTM configured for learning negative class embedding in their corresponding latent spaces, the first LSTM, the second LSTM, and the third LSTM having identical sub-network architecture configurations;
generate, by the machine learning training engine, a set of training tuples from the dataset, the set of training tuples expanding a number of records of the dataset by including extended training examples based on different combinations of a record of the positively labelled records or the negatively labelled records being assigned as an anchor coupled with two other records as positive and negatively records such that each training tuple contains a positive record, an anchor record, and a negative record;
train, by the machine learning training engine, the first LSTM, the second LSTM and the third LSTM using a loss function that is configured to minimize a distance between the positive record and the anchor record and maximize a distance between the anchor record and the negative record;
receive, at the data receiver interface, a new data object for classification;
generate one or more inference tuples where the new data object is represented as the anchor record, and a positive record and a negative record are obtained from two other records; and
process the one or more inference tuples to generate a classification output logit representative of a confidence score associated with a classification label of positive or negative.

2. The system of claim 1, wherein the free-text inputs are strings representing addresses, the positive classification label represents a multiple country address string, and the negative classification label represents a single country address string.

3. The system of claim 2, wherein the classification output logit is normalized using a dense layer to generate a metadata output corresponding to the classification label having a higher probability and a normalized confidence score.

4. The system of claim 3, wherein the metadata output is appended onto a data structure storing the free-text inputs, the metadata output adding an additional column and corresponding fields for each of free-text input of the free-text inputs

5. The system of claim 4, wherein the appended data structure is compressed to only include rows corresponding to free text inputs of the free-text inputs where the normalized confidence score is less than a pre-defined threshold.

6. The system of claim 5, wherein the compressed data structure is provided to a reviewer graphical user interface system for manual reviewers and relabeling, the reviewer graphical user interface system appending additional metadata tags corresponding to a correct label for each free text inputs of the free-text inputs.

7. The system of claim 6, wherein the compressed data structure and the additional metadata tags are utilized automatically as a retraining dataset for re-training the Siamese triplet LSTM network architecture.

8. The system of claim 7, wherein the retrained Siamese triplet LSTM network architecture is utilized to generate an updated data structure, and if every free-text input of the free-text inputs is classified with a corresponding classification label having a normalized confidence score greater than a pre-defined threshold, the updated data structure is provided through a message bus as a data object configured to invoke downstream compliance validation sub-processes corresponding to country strings identified in the free-text inputs.

9. The system of claim 7, wherein the retrained Siamese triplet LSTM network architecture is utilized to generate an updated data structure, and if every free-text input of the free-text inputs is classified with a corresponding classification label having a normalized confidence score greater than a pre-defined threshold and classified as relating to a single country, the updated data structure is provided through a message bus as a data object configured to invoke downstream compliance validation sub-processes corresponding to country strings identified in the free-text inputs.

10. The system of claim 1, wherein the computer processor is coupled to a special purpose computing appliance operating in a data center that is configured to receive, from a message bus, the dataset having one or more positively labelled records and one or more negatively labelled records, and provide, on the message bus, the classification output logit for usage by a downstream computing subroutine.

11. A method for machine learning-based data field validation of free-text inputs using a Siamese triplet long-short term model (LSTM) network architecture, the method comprising:
receiving, at a data receiver interface, a dataset having one or more positively labelled records and one or more negatively labelled records, the dataset having a class imbalance between a number of positively labelled records and a number of negatively labelled records;
instantiating, by a machine learning training engine, an untrained Siamese triplet LSTM network architecture including a first LSTM configured for learning a positive class embedding, a second LSTM configured for learning an anchor class embedding, and a third LSTM configured for learning negative class embedding in their corresponding latent spaces, the first LSTM, the second LSTM, and the third LSTM having identical sub-network architecture configurations;
generating, by the machine learning training engine, a set of training tuples from the dataset, the set of training tuples expanding a number of records of the dataset by including extended training examples based on different combinations of a record of the positively labelled records or the negatively labelled records being assigned as an anchor coupled with two other records as positive and negatively records such that each training tuple contains a positive record, an anchor record, and a negative record;
training, by the machine learning training engine, the first LSTM, the second LSTM and the third LSTM using a loss function that is configured to minimize a distance between the positive record and the anchor record and maximize a distance between the anchor record and the negative record;
receiving, at the data receiver interface, a new data object for classification;
generating one or more inference tuples where the new data object is represented as the anchor record, and a positive record and a negative record are obtained from two other records; and
processing the one or more inference tuples to generate a classification output logit representative of a confidence score associated with a classification label of positive or negative.

12. The method of claim 11, wherein the free-text inputs are strings representing addresses, the positive classification label represents a multiple country address string, and the negative classification label represents a single country address string.

13. The method of claim 12, wherein the classification output logit is normalized using a dense layer to generate a metadata output corresponding to the classification label having a higher probability and a normalized confidence score.

14. The method of claim 13, wherein the metadata output is appended onto a data structure storing the free-text inputs, the metadata output adding an additional column and corresponding fields for each of free-text input of the free-text inputs.

15. The method of claim 14, wherein the appended data structure is compressed to only include rows corresponding to free text inputs of the free-text inputs where the normalized confidence score is less than a pre-defined threshold.

16. The method of claim 15, wherein the compressed data structure is provided to a reviewer graphical user interface system for manual reviewers and relabeling, the reviewer graphical user interface system appending additional metadata tags corresponding to a correct label for each free text inputs of the free-text inputs.

17. The method of claim 16, wherein the compressed data structure and the additional metadata tags are utilized automatically as a retraining dataset for re-training the Siamese triplet LSTM network architecture.

18. The method of claim 17, wherein the retrained Siamese triplet LSTM network architecture is utilized to generate an updated data structure, and if every free-text input of the free-text inputs is classified with a corresponding classification label having a normalized confidence score greater than a pre-defined threshold, the updated data structure is provided through a message bus as a data object configured to invoke downstream compliance validation sub-processes corresponding to country strings identified in the free-text inputs.

19. The method of claim 17, wherein the retrained Siamese triplet LSTM network architecture is utilized to generate an updated data structure, and if every free-text input of the free-text inputs is classified with a corresponding classification label having a normalized confidence score greater than a pre-defined threshold and classified as relating to a single country, the updated data structure is provided through a message bus as a data object configured to invoke downstream compliance validation sub-processes corresponding to country strings identified in the free-text inputs.

20. A non-transitory computer readable medium storing machine interpretable instructions, which when executed by a processor, cause the processor to perform a method A method for machine learning-based data field validation of free-text inputs using a Siamese triplet long-short term model (LSTM) network architecture, the method comprising:
receiving, at a data receiver interface, a dataset having one or more positively labelled records and one or more negatively labelled records, the dataset having a class imbalance between a number of positively labelled records and a number of negatively labelled records;
instantiating, by a machine learning training engine, an untrained Siamese triplet LSTM network architecture including a first LSTM configured for learning a positive class embedding, a second LSTM configured for learning an anchor class embedding, and a third LSTM configured for learning negative class embedding in their corresponding latent spaces, the first LSTM, the second LSTM, and the third LSTM having identical sub-network architecture configurations;
generating, by the machine learning training engine, a set of training tuples from the dataset, the set of training tuples expanding a number of records of the dataset by including extended training examples based on different combinations of a record of the positively labelled records or the negatively labelled records being assigned as an anchor coupled with two other records as positive and negatively records such that each training tuple contains a positive record, an anchor record, and a negative record;
training, by the machine learning training engine, the first LSTM, the second LSTM and the third LSTM using a loss function that is configured to minimize a distance between the positive record and the anchor record and maximize a distance between the anchor record and the negative record;
receiving, at the data receiver interface, a new data object for classification;
generating one or more inference tuples where the new data object is represented as the anchor record, and a positive record and a negative record are obtained from two other records; and
processing the one or more inference tuples to generate a classification output logit representative of a confidence score associated with a classification label of positive or negative.
